(19) United States
(12) Patent Application Publication
(10) Pub. No.: US 2026/0320645 A1
(43) Pub. Date: Oct. 15, 2026

(54) CONTENT MANAGEMENT SYSTEM AND CONTENT MANAGEMENT METHOD

(71) Applicant: Sharp Kabushiki Kaisha, Sakai City (JP)

(72) Inventors: Kengo TSURUZONO, Sakai City (JP); Michio TOMIZAWA, Sakai City (JP)

(21) Appl. No.: 19/699,790

(22) Filed: Jun. 5, 2026

Related U.S. Application Data
(63) Continuation of application No. PCT/JP2024/002459, filed on Jan. 26, 2024.

(51) Int. Cl. G06Q 30/0207; G06Q 10/40

(52) U.S. Cl. CPC G06Q 30/0239; G06Q 10/40

(57) ABSTRACT

A content management system is configured to generate evaluation content including details of evaluation of a facility itself or a commodity provided at the facility in association with a contributor, to release the generated evaluation content in a first environment which is an evaluation content site, to store the evaluation content released in the first environment in a storage device in association with reaction information including at least one of the number of views and the number of interactions, to select evaluation content out of the stored evaluation content on the basis of the reaction information, for a second release device configured to release all or part of the evaluation content selected in a predetermined second environment different from the first environment, and to grant a reward to the contributor associated with the evaluation content on the basis of the evaluation content released by the second release device.

### BACKGROUND OF THE INVENTION

### Field of the Invention

The present invention relates to a content management system and a content management method.

### Description of Related Art

Contributions for evaluation of services or products by general users can be released on a reputation information site (for example, see Patent Document 1).

### PATENT DOCUMENTS

[Patent Document 1] Japanese Unexamined Patent Application, First Publication No. 2003-345941

### SUMMARY OF THE INVENTION

It is preferable to achieve improvement in quality of details of content (evaluation content) which is contributed as an evaluation result by a general user.

Therefore, an objective of the present invention is to achieve improvement in quality of details of evaluation content to be contributed.

According to an aspect of the present invention, there is provided a content management system including: a content generator configured to generate evaluation content including details of evaluation of a facility itself or a commodity provided at the facility in association with a contributor; a first release device configured to release the evaluation content generated by the content generator in a first environment which is an evaluation content site; a storage device configured to store the evaluation content released by the first release device in association with reaction information indicating a reaction status with respect to the released evaluation content; a content selector configured to select evaluation content out of the evaluation content stored in the storage device on the basis of the reaction information; a second release device configured to release all or part of the evaluation content selected by the content selector in a predetermined second environment different from the first environment; and a reward granter configured to grant a reward to the contributor associated with the evaluation content on the basis of the evaluation content released by the second release device.

According to another aspect of the present invention, there is provided a content management method in a content management system, the content management method including: a content generating step of causing a content generator to generate evaluation content including details of evaluation of a facility itself or a commodity provided at the facility in association with a contributor; a first release step of causing a first release device to release the evaluation content generated in the content generating step in a first environment which is an evaluation content site; a storage step of causing a storage device to store the evaluation content released by the first release device in association with reaction information indicating a reaction status with respect to the released evaluation content; a selection step of causing a content selector to select evaluation content out of the evaluation content stored in the storage device on the basis of the reaction information; a second release step of causing a second release device to release all or part of the evaluation content selected in the selection step in a predetermined second environment different from the first environment; and a reward giving step of causing a reward granter to grant a reward to the contributor associated with the evaluation content on the basis of the evaluation content released in the second release step.

According to the present invention, it is possible to achieve improvement in quality of details of evaluation content to be contributed.

### BRIEF DESCRIPTION OF THE DRAWINGS

FIG. 1 is a diagram illustrating an example of an entire configuration of an evaluation content management system according to a first embodiment.

FIG. 2 is a diagram illustrating an example of an evaluation content format selection screen according to the first embodiment.

FIG. 3 is a diagram illustrating an example of a content editing screen according to the first embodiment.

FIG. 4 is a diagram illustrating an example of a content selection screen according to the first embodiment.

FIG. 5 is a diagram illustrating an example of functional configurations of an evaluation content management device and a store terminal according to the first embodiment.

FIG. 6 is a diagram illustrating an example of contributor information according to the first embodiment.

FIG. 7 is a diagram illustrating an example of evaluation content in a site format according to the first embodiment.

FIG. 8 is a diagram illustrating an example of evaluation content in a signage format according to the first embodiment.

FIG. 9 is a diagram illustrating an example of a sequence that is performed by the evaluation content management system according to the first embodiment.

FIG. 10 is a diagram illustrating an example of an entire configuration of an evaluation content management system according to a second embodiment.

FIG. 11 is a diagram illustrating an example of functional configurations of an evaluation content management device and an SNS server according to the second embodiment.

FIG. 12 is a diagram illustrating an example of a sequence that is performed by the evaluation content management system according to the second embodiment.

FIG. 13 is a diagram illustrating an example of an entire configuration of an evaluation content management system according to a third embodiment.

FIG. 14 is a diagram illustrating an example of functional configurations of an evaluation content management device and an SNS server according to the third embodiment.

FIG. 15 is a diagram illustrating an example of a sequence that is performed by the evaluation content management system according to the third embodiment.

FIG. 16 is a diagram illustrating an example of a basic configuration in the embodiments.

### DETAILED DESCRIPTION OF THE INVENTION

### First Embodiment

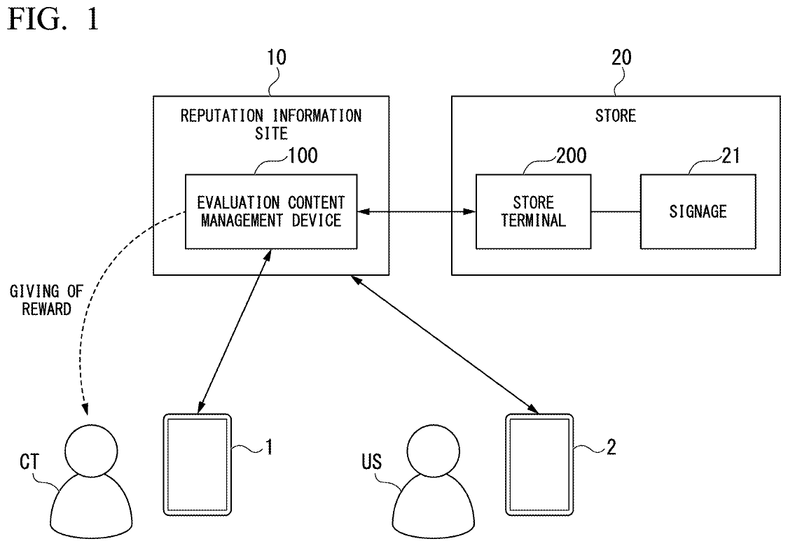

FIG. 1 is a diagram illustrating an example of a whole configuration of an evaluation content management system (an example of a content management system) according to a first embodiment.

In the drawing, a contributor CT generates evaluation content which is an evaluation result of commodities (products or services) provided in a store or a facility including the whole store or a building itself using a contributor terminal 1 and contributes the generated evaluation content as reputation information to a reputation information site 10.

The contributor terminal 1 is a terminal that is used by a contributor CT. The contributor terminal 1 is communicatively connected to an evaluation content management device 100 via a network. The contributor terminal 1 may be, for example, a smartphone, a tablet terminal, or a personal computer.

In the drawing, one contributor CT Is illustrated, but a plurality of contributors CT may be provided. Each of the plurality of contributors CT uses a contributor terminal 1.

The reputation information site 10 is a site in which evaluation content contributed over a network such as the Internet is released as reputation information.

The reputation information site 10 includes an evaluation content management device 100. The evaluation content management device 100 may be a server that is provided over the network or may be constructed as a cloud server.

The evaluation content management device 100 generates evaluation content according to operations of a contributor CT generating and contributing (registering) evaluation content and stores the generated evaluation content.

In the present embodiment, the evaluation content can be arbitrarily selectively generated in a site format (an example of a first format) corresponding to disclosure in a web site (an example of a first environment) which is the reputation information site 10 and a signage format (an example of a second format) corresponding to reproduction (display) in a signage 21 (an example of a second environment) which is installed in a store 20 (an example of a predetermined place) and used by the store 20 (an example of a user).

The evaluation content (an example of first evaluation content) in the site format supporting for disclosure in a web site which is the reputation information site 10 may not be suitable for reproduction in the signage 21, for example, in a layout of information in many cases.

Therefore, in the present embodiment, the signage format suitable for reproduction in the signage 21 can be determined, and evaluation content can be generated in the signage format. In this way, by generating the signage format, it is possible to enhance appeal for customers using evaluation content which is reproduced in the signage 21.

The evaluation content management device 100 releases evaluation content generated in the site format out of the contributed evaluation content as reputation information in the web site which is the reputation information site 10.

The evaluation content in the site format released in the reputation information site 10 is viewed by a consumer user US. The consumer user US is a user who is a consumer purchasing a product or a service provided by the store 20. The consumer user US performs an operation of causing a consumer terminal 2 to access (log in to) the reputation information site 10. A screen of the reputation information site 10 is displayed on the consumer terminal 2.

The consumer user US can select evaluation content in the site format through an operation on the screen of the reputation information site 10 and view the selected evaluation content.

The consumer user US can adopt reaction in response to viewing of the evaluation content in the site format presented in the reputation information site 10. Specifically, the reaction may include the number of views of the evaluation content in the site format. The reaction may be an evaluation operation (for example, an operation on a “like” button) for the evaluation content in the site format, an operation of bookmarking the evaluation content in the site format, an operation of making an order or a reservation via the evaluation content in the site format, or the like.

In the drawing, the store 20 reproduces evaluation content in a signage format (an example of second evaluation content) for the store 20 in the signage 21 in cooperation with the reputation information site 10.

The store 20 includes a store terminal 200 which is operated by a clerk. The store terminal 200 may be a personal computer, a smartphone, a tablet terminal, or the like.

The store terminal 200 is communicatively connected to the evaluation content management device 100 via a network. The store terminal 200 downloads evaluation content in the signage format for the store from the evaluation content management device 100 and causes the signage 21 to reproduce the downloaded evaluation content.

In the store 20, for example, a clerk can operate the store terminal 200 to select evaluation content to be reproduced in the signage 21 out of the evaluation content in the signage format for the store.

That is, in the present embodiment, for example, only evaluation content determined to be preferable in the store 20 by a clerk out of the evaluation content in the signage format for the store can be reproduced by the signage 21.

In the store 20, when a customer (a consumer) sees the evaluation content displayed on the signage 21, an advertisement effect is acquired. The customer can appropriately determine purchase of a product or a service according to details of the evaluation content.

In the present embodiment, the evaluation content management device 100 may grant a reward to the contributor CT of the reproduced evaluation content when the evaluation content has been reproduced by the signage 21.

The type of the reward is not particularly limited and may be money, points, coupons, or the like.

Various rules of giving a reward in response to reproduction of evaluation content in the signage 21 can be considered and are not particularly limited.

In this way, in the present embodiment, evaluation content contributed to the reputation information site 10 by the contributor CT is released in the signage 21 which is an environment other than the reputation information site 10, and a reward is grantn to the contributor CT in response to disclosure in the signage 21. By giving a reward in this way, it is possible to grant an incentive for contribution of evaluation content with as good quality as possible to the contributor CT according to a reward giving method. As a result, in the present embodiment, it is possible to expect voluntary improvement in the quality of the evaluation content by the contributor CT or the like.

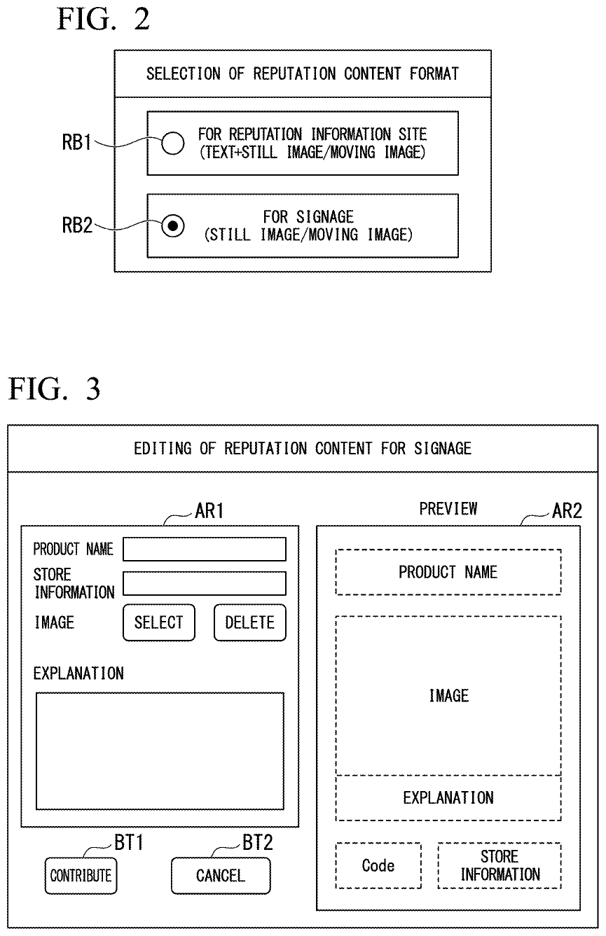

An example of an operation sequence corresponding to generation of evaluation content in a signage format by a contributor CT will be described with reference to FIGS. 2 and 3.

In generating evaluation content in the signage format, a contributor CT causes a browser of the contributor terminal 1 to access the reputation information site 10 and to display a web page for generation of evaluation content.

In the web page for generation of evaluation content, for example, an evaluation content format selection screen is first displayed. The evaluation content format selection screen is a screen on which an operation of designating which of the site format and the signage format is used as the format of evaluation content to be generated is performed.

FIG. 2 illustrates an example of the evaluation content format selection screen. In this case, a user designates the signage format as evaluation content to be generated by operating a radio button RB2 out of a radio button RB1 corresponding to the site format and the radio button RB2 corresponding to the signage format.

When the signage format is designated through an operation on the radio button RB2, a content editing screen corresponding to the evaluation content in the signage format is displayed in the web page for generation of evaluation content.

FIG. 3 illustrates an example of the content editing screen corresponding to evaluation content in the signage format.

In the content editing screen illustrated in the drawing, an information input area AR1 and a preview area AR2 are disposed.

The information input area AR1 is an area on which an input operation corresponding to each information item presented in evaluation content in the signage format is performed.

The preview area AR2 is an area on which a preview in which details of the information item input to the information input area AR1 are reflected in the evaluation content screen displayed in the signage is displayed.

In the information input area AR1, an input box to which a product name can be input, an input box to which store information can be input, buttons (a “select” button, a “delete” button) on which an operation of designating an image embedded in the screen of evaluation content is performed, and an input box to which an explanation can be input are disposed.

When a contributor designates an image by performing an input operation to each input box or an operation on a button (the “select” button, the “delete” button), information corresponding to the areas such as a product name, an image, an explanation, store information, and a code is displayed in the preview area AR2. A store input as the store information is a store to be evaluated. For example, a code symbol of a store ID indicating the store indicated by the store information is displayed in the area of a code. The code symbol may be, for example, a two-dimensional code.

The contributor CT operates a contribution button BT1 when details displayed in the preview area AR2 according to the contributor's own operation are ascertained.

When the contribution button BT1 is operated, the evaluation content management device 100 stores the evaluation content in the signage format based on the details displayed in the preview area AR2 up to now.

When it is intended to cancel details input to the content editing screen and to return to a previous screen, the contributor CT operates the cancel button BT2.

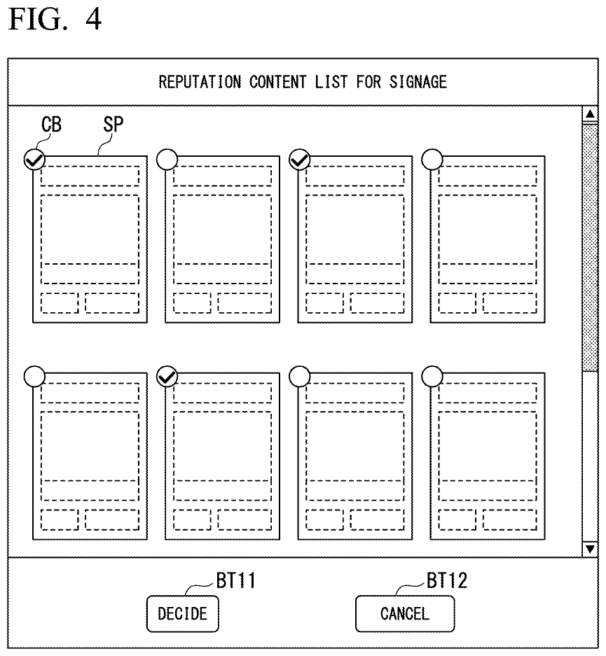

An example of an operation sequence performed by a clerk of the store 20 for selecting evaluation content in the signage format to be reproduced by the signage 21 will be described below with reference to FIG. 4. FIG. 4 illustrates an example of a content selection screen which is displayed on the store terminal 200 when the store terminal 200 accesses the evaluation content management device 100.

As illustrated in FIG. 4, a list of evaluation content in the signage format contributed for the store 20 is presented in the content selection screen. In the list of evaluation content, a sample image SP for each piece of evaluation content is disposed. A check box CB is added for each sample image SP.

Here, images corresponding to some selected out of all the contributed evaluation content in the signage format may be disposed as the sample images SP in the content selection screen. Selection of the evaluation content in the signage format may be performed, for example, on the basis of reaction information indicating a status of reaction (a reaction status) adopted up to now by the consumer user US in response to the evaluation content in the site format correlated with the evaluation content in the signage format.

Specifically, the reaction information may be the number of views of the corresponding evaluation content in the site format, the number of “likes,” the number of registered bookmarks, or the number of orders or the number of reservations performed up to now via the evaluation content in the site format. In this case, in a method of selecting the evaluation content in the signage format, a predetermined number of pieces of evaluation content may be selected in the descending order of the number of reactions in the reaction information (the number of views, the number of “likes,” the number of registered bookmarks, the number of orders, or the number of reservations, or the like), or evaluation content in which the number of reactions is equal to or greater than a predetermined value may be selected. Alternatively, a predetermined number of pieces of evaluation content may be selected in the ascending order of the number of reactions, or evaluation content in which the number of reactions is equal to or less than a predetermined value may be selected. The selection method may be able to switch according to a clerk's operation. The number of reactions (the number of views, the number of “likes,” the number of registered bookmarks, the number of orders, or the number of reservations, or the like) used as conditions for selecting the evaluation content in the signage format may be able to be selected by a clerk's operation.

A clerk ascertains details for each sample image SP of the evaluation content disposed at the content selection screen. At this time, the clerk may display an enlarged image of the designated sample image SP to ascertain details thereof according to necessity.

The clerk ascertains the details, checks the check box CB corresponding to the evaluation content to be displayed in the signage 21, and operates a “decide” button BT11. Through this operation, evaluation content to be displayed in the signage 21 is determined.

The evaluation content management device 100 transmits the evaluation content in the signage format selected through the operation to the store terminal 200. The store terminal 200 stores the received evaluation content in the signage format. The store terminal 200 reproduces the evaluation content in the signage 21 by outputting the stored evaluation content to the signage 21.

The signage 21 may be configured to be communicatively connected to the evaluation content management device 100. In this case, the evaluation content management device 100 may cause the signage 21 to reproduce the evaluation content in the signage format selected by the operation on the content selection screen illustrated in FIG. 4 by sequentially transmitting the evaluation content in the signage format to the signage 21 without passing through the store terminal 200.

When it is intended to cancel details input to the content selection screen and to return to, for example, a previous screen, the contributor CT operates the cancel button BT12.

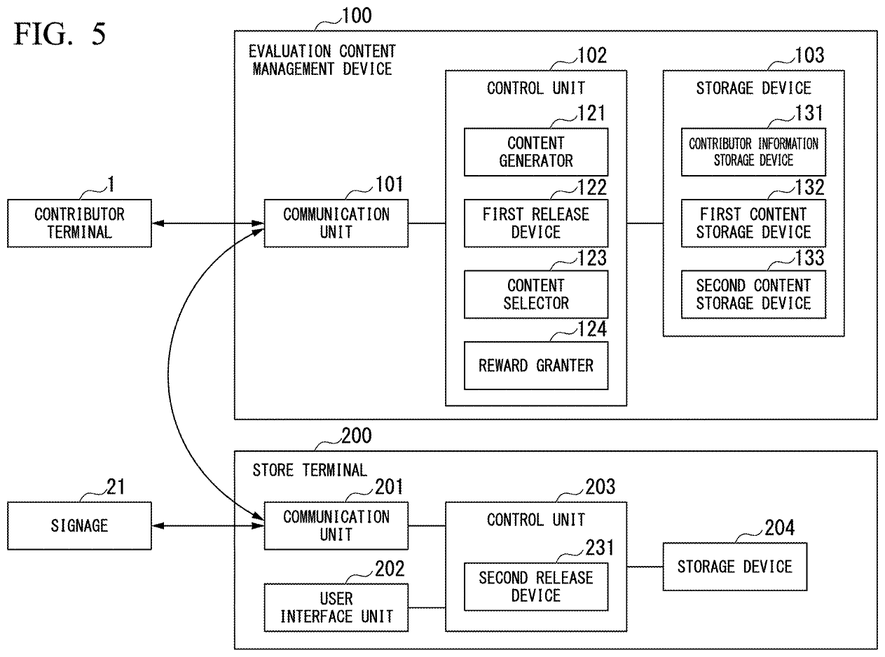

FIG. 5 illustrates an example of a functional configuration of the evaluation content management device 100 and the store terminal 200 according to the present embodiment.

Each of the evaluation content management device 100 and the store terminal 200 may include a central processing unit (CPU), a read only memory (ROM), a random access memory (RAM), or a storage device such as a hard disk drive (HDD) or a solid state drive (SSD) as hardware. The functions of the evaluation content management device 100 illustrated in the drawing are realized by causing the CPU provided in the evaluation content management device 100 to execute a program. The functions of the store terminal 200 illustrated in the drawing are realized by causing the CPU provided in the store terminal 200 to execute a program.

An example of the functional configuration of the evaluation content management device 100 will be first described. The evaluation content management device 100 includes a communication unit 101, a control unit 102, and a storage device 103.

The communication unit 101 is communicatively connected to the contributor terminal 1 or the store terminal 200 via a network.

The control unit 102 performs various types of control in the evaluation content management device 100. The control unit 102 includes a content generator 121, a first release device 122, a content selector 123, and a reward granter 124.

The content generator 121 generates evaluation content in the site format and evaluation content in the signage format according to a content generating operation performed on the contributor terminal 1 having accessed the evaluation content management device 100 by the contributor CT.

The first release device 122 releases the evaluation content in the site format generated by the content generator 121 in the web site which is the reputation information site 10.

The content selector 123 selects evaluation content in the signage format according to an evaluation content selecting operation performed on the content selection screen (FIG. 4) displayed on the store terminal 200 having accessed the evaluation content management device 100 by a clerk.

The reward granter 124 performs a process of giving a reward to the contributor CT when the evaluation content generated by the contributor CT has been reproduced in the signage 21 or ascertainment of motivation of a consumer for consumption experience such as product purchase or the like has been acquired.

The storage device 103 stores various types of information associated with the evaluation content management device 100. The storage device 103 includes a contributor information storage device 131, a first content storage device 132, and a second content storage device 133.

The contributor information storage device 131 stores information of each contributor (contributor information).

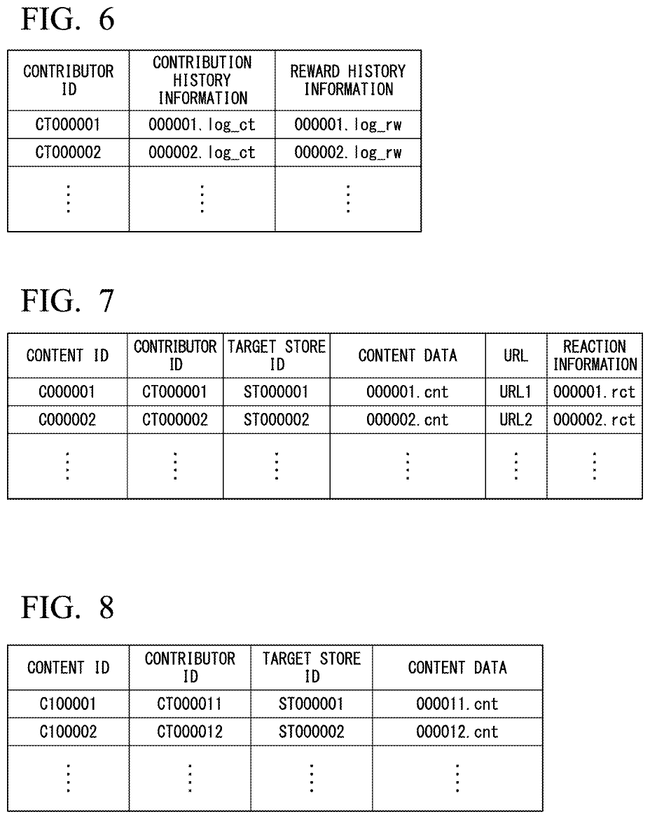

FIG. 6 illustrates an example of contributor information stored in the contributor information storage device 131. One record (one row) in the drawing is contributor information corresponding to one contributor.

Contributor information corresponding to one contributor includes fields of contributor ID, contribution history information, and reward history information.

The field of contributor ID stores a contributor ID uniquely identifying a corresponding contributor.

The field of contribution history information stores contribution history information indicating a history of contribution of evaluation content (evaluation content in the site format and evaluation content in the signage format) from the corresponding contributor up to now.

The field of reward history information stores reward history information indicating a history of giving a reward to the corresponding contributor.

Description will be continued with reference back to FIG. 5. The first content storage device 132 stores the contributed evaluation content in the site format.

FIG. 7 illustrates an example of evaluation content in the site format stored in the first content storage device 132. One record (one row) in the drawing corresponds to one piece of evaluation content in the site format. The evaluation content in the site format includes fields of content ID, contributor ID, target store ID, content data, uniform resource locator (URL), and reaction information.

The field of content ID stores a content ID uniquely identifying corresponding evaluation content in the site format.

The field of contributor ID stores a contributor ID uniquely identifying a contributor having generated and contributed the corresponding evaluation content in the site format.

The field of target store ID stores a store ID uniquely identifying a store 20 to be evaluated by the corresponding evaluation content in the site format.

The field of content data stores actual data of the corresponding evaluation content in the site format.

The field of URL stores a URL which is set for disclosing the corresponding evaluation content in the site format in the web site which is the reputation information site 10.

The field of reaction information stores reaction information indicating a reaction status with respect to the corresponding evaluation content in the site format. As described above, the reaction information may be the number of views, the number of “likes,” the number of registered bookmarks, the number of orders or the number of reservations performed via the evaluation content in the site format, or the like.

Description will be continued with reference back to FIG. 5. The second content storage device 133 stores contributed evaluation content in the signage format.

FIG. 8 illustrates an example of evaluation content in the signage format stored in the second content storage device 133. One record (one row) in the drawing corresponds to one piece of evaluation content in the signage format. The evaluation content in the signage format includes fields of content ID, contributor ID, target store ID, and content data.

The field of content ID stores a content ID uniquely identifying corresponding evaluation content in the signage format.

The field of contributor ID stores a contributor ID uniquely identifying a contributor having generated and contributed the corresponding evaluation content in the signage format.

The field of target store ID stores a store ID uniquely identifying a store 20 to be evaluated by the corresponding evaluation content in the signage format.

The field of content data stores actual data of the corresponding evaluation content in the signage format.

In the present embodiment, the evaluation content in the site format stored in the first content storage device 132 and the evaluation content in the signage format stored in the second content storage device 133 may be managed in association with each other. In this case, the correlation between the evaluation content in the site format and the evaluation content in the signage format may be a one-to-one relation, a one-to-multiple relation, or a multiple-to-one relation.

Specifically, the correlation between the evaluation content in the site format and the evaluation content in the signage format may be performed, for example, on the basis of a common product or service designated in the content data. The correlation between the evaluation content in the site format and the evaluation content in the signage format may be performed, for example, on the basis of a common contributor ID in the evaluation content in the site format and the evaluation content in the signage format.

When a contributor CT registers evaluation content in the site format, the evaluation content in the signage format to be correlated with the evaluation content in the site format which is currently registered may be designated out of the evaluation content in the signage format registered in advance. When a contributor CT registers evaluation content in the signage format, the evaluation content in the site format to be correlated with the evaluation content in the signage format which is currently registered may be designated out of the evaluation content in the site format registered in advance. In this way, when a contributor CT designates a correlation, correlation information indicating the evaluation content in the site format and the evaluation content in the signage format correlated with each other may be stored in the storage device 103.

Description will be continued with reference back to FIG. 5. The functional configuration of the store terminal 200 will be described below. The store terminal 200 includes a communication unit 201, a user interface unit 202, a control unit 203, and a storage device 204.

The communication unit 201 is communicatively connected to the evaluation content management device 100 via a network. The communication unit 201 is connected to the signage 21 via the network or via a predetermined data interface.

The user interface unit 202 is a unit including an operation unit or a display unit provided in the store terminal 200.

The control unit 203 performs various types of control in the store terminal 200. The control unit 203 includes a second release device 231.

The second release device 231 causes the signage 21 to reproduce the evaluation content in the signage format by outputting the evaluation content in the signage format transmitted from the evaluation content management device 100 in response to an operation on the content selection screen (FIG. 4) to the signage 21. That is, the second release device 231 releases evaluation content in the signage 21.

The storage device 204 stores various types of information corresponding to the store terminal 200. The storage device 204 may store, for example, the evaluation content in the signage format transmitted from the evaluation content management device 100.

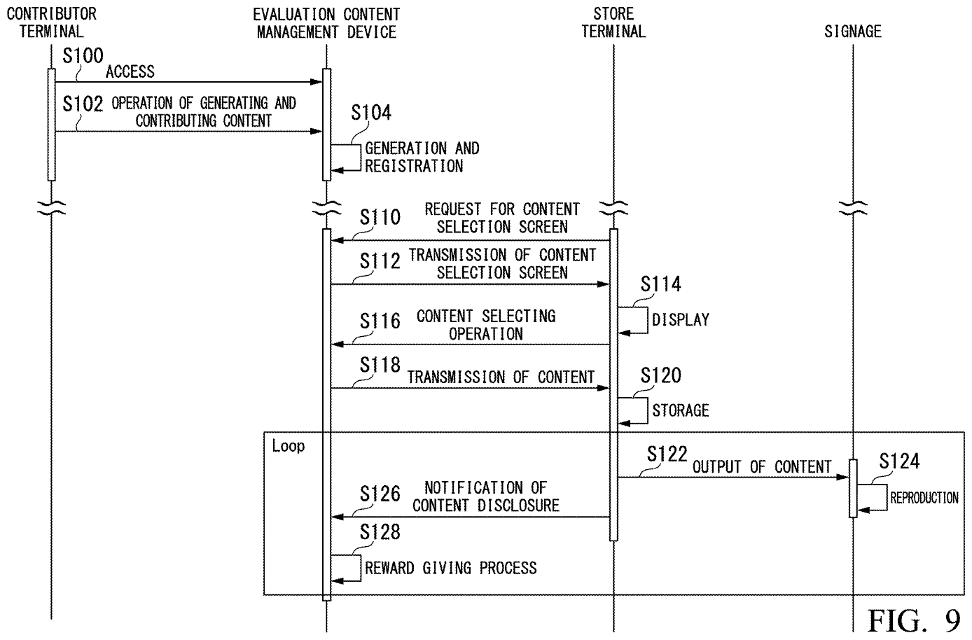

An example of a sequence that is performed in association with contribution of evaluation content and reproduction of evaluation content in the signage format in the signage 21 in the evaluation content management system according to the present embodiment will be described with the sequence diagram illustrated in FIG. 9.

An example of a sequence associated with contribution of evaluation content will be first described.

Step S100: The contributor terminal 1 accesses the evaluation content management device 100 in response to an operation of a contributor CT.

Step S102: In the contributor terminal 1 having accessed the evaluation content management device 100, an operation screen (the evaluation content format selection screen (FIG. 2), the content editing screen (FIG. 3), or the like) corresponding to generation of evaluation content is displayed. The contributor CT performs operations such as selection of a format of evaluation content to be generated, generation of evaluation content, and contribution of the generated evaluation content on the displayed operation screen.

Step S104: The content generator 121 in the evaluation content management device 100 performs a process associated with generation and registration of evaluation content according to an operation performed on the contributor terminal 1 in Step S102. Registration of evaluation content is performed by causing the content generator 121 to store the generated evaluation content in the first content storage device 132 or the second content storage device 133. At this time, the content generator 121 may update the contribution history information (FIG. 6) in the corresponding contributor information.

An example of a sequence that is performed in association with reproduction of evaluation content in the signage format in the signage 21 according to the present embodiment will be described below.

Step S110: A clerk operates the store terminal 200 to access the evaluation content management device 100 and to transmit a content selection screen request thereto. The content selection screen request includes a store ID of the corresponding store 20.

Step S112: The content selector 123 in the evaluation content management device 100 acquires evaluation content in the signage format which is stored with the store ID included in the received content selection screen request as a target store ID from the second content storage device 133.

For example, the content selector 123 may acquire (select) evaluation content in the signage format correlated with evaluation content in the site format including content data for the same product as designated by the clerk's operation on the content selection screen from the second content storage device 133.

The content selector 123 may select the evaluation content in the signage format acquired from the second content storage device 133 on the basis of reaction information to the evaluation content in the site format as described above.

The content selector 123 generates a content selection screen for presenting a sample image SP of the acquired evaluation content and transmits the generated content selection screen to the store terminal 200.

Step S114: The store terminal 200 displays the content selection screen transmitted in Step S112 on the display unit of the user interface unit 202.

Step S116: The content selector 123 in the evaluation content management device 100 receives a selection operation which is performed on the content selection screen displayed on the store terminal 200.

Step S118: The content selector 123 transmits the evaluation content in the signage format selected through the selection operation performed on the content selection screen.

Step S120: The second release device 231 in the store terminal 200 stores the evaluation content in the signage format transmitted in Step S118 in the storage device 204.

In the process of Step S116, a clerk performs an operation of selecting evaluation content. However, the content selector 123 in the evaluation content management device 100 may select evaluation content suitable for reproduction in the signage 21, for example, when the clerk performs an operation of instructing to select evaluation content on the store terminal 200. In this case, the content selector 123 may select content suitable for reproduction using a trained model having been trained through deep learning or the like.

Step S122: The second release device 231 outputs the evaluation content in the signage format stored in the storage device 204 to the signage 21 according to a clerk's operation or according to a predetermined schedule.

Step S124: The signage 21 reproduces the evaluation content in the signage format transmitted from the store terminal 200 in Step S122.

Step S126: The second release device 231 transmits a notification indicating that the evaluation content in the signage format has been released (a content disclosure notification) to the evaluation content management device 100 when the evaluation content in the signage format is output to the signage 21 in Step S122.

The content disclosure notification includes a content ID of the evaluation content in the signage format output in Step S122.

Step S128: The reward granter 124 in the evaluation content management device 100 identifies the contributor CT having contributed the evaluation content with the content ID included in the content disclosure notification transmitted from the store terminal 200 in Step S126 with reference to the second content storage device 133.

The reward granter 124 performs a process of giving a reward to the identified contributor CT (a reward giving process). The reward granter 124 updates the reward history information in the contributor information (FIG. 6) of the corresponding contributor CT such that the result of this reward giving process is reflected.

The processes of Steps S122 to S128 serve as a loop process which is performed whenever the store terminal 200 outputs one piece of evaluation content in the signage format and reproduces the evaluation content in the signage 21.

The evaluation content management device 100 may transmit the evaluation content in the signage format to the signage 21 without passing through the store terminal 200 and cause the signage 21 to reproduce the evaluation content in the signage format. In this case, the second release device 231 may be provided in the control unit 102 of the evaluation content management device 100. In this case, the reward granter 124 may perform the reward giving process whenever the second release device 231 in the evaluation content management device 100 transmits evaluation content in the signage format to the signage 21.

When the signage 21 has reproduced evaluation content in the signage format and it is detected that a customer in the store 20 adopts predetermined reaction to the reproduced evaluation content in the signage format, a reward may be grantn to the corresponding contributor CT.

A customer's reaction to the evaluation content in the signage format reproduced in the signage 21 may be, for example, viewing the evaluation content in the signage format reproduced in the signage 21 during a predetermined time or longer. In this case, for example, a sensor that can detect a customer (a person) present in front of the signage 21 such as a camera or a motion sensor may be provided, and a reward may be grantn to the corresponding contributor CT, for example, when a customer continuously stands in front of the signage 21 during a predetermined time or longer on the basis of an output from the sensor. In this case, the signage 21 or the store terminal 200 may transmit the detection result based on the output from the sensor to the evaluation content management device 100.

In the aforementioned description, as the format of evaluation content, two different formats including the site format for disclosure in the reputation information site 10 and the signage format can be generated. However, for example, evaluation content may be generated in one common format which can be shared for disclosure in the reputation information site 10 and disclosure (display) in the signage 21.

The display device used to release evaluation content in the second environment may be, for example, a display device such as a general monitor device and a tablet terminal other than the signage 21.

### Second Embodiment

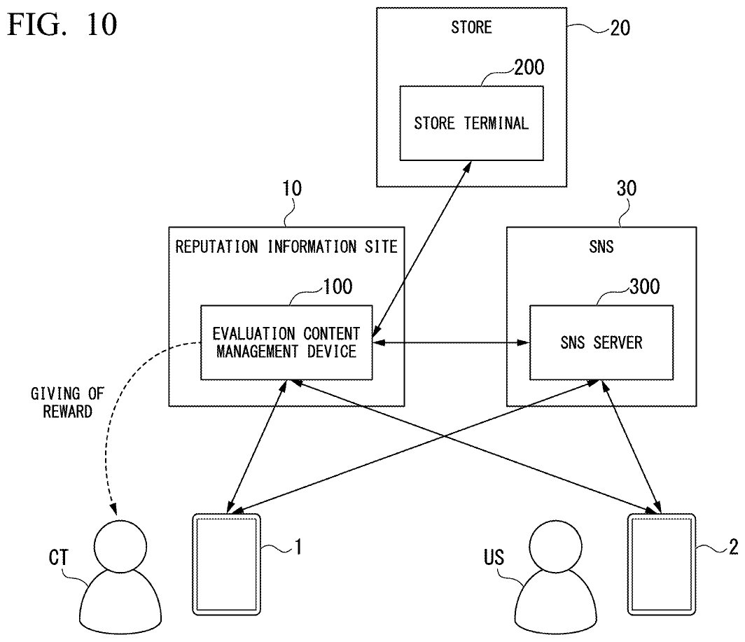

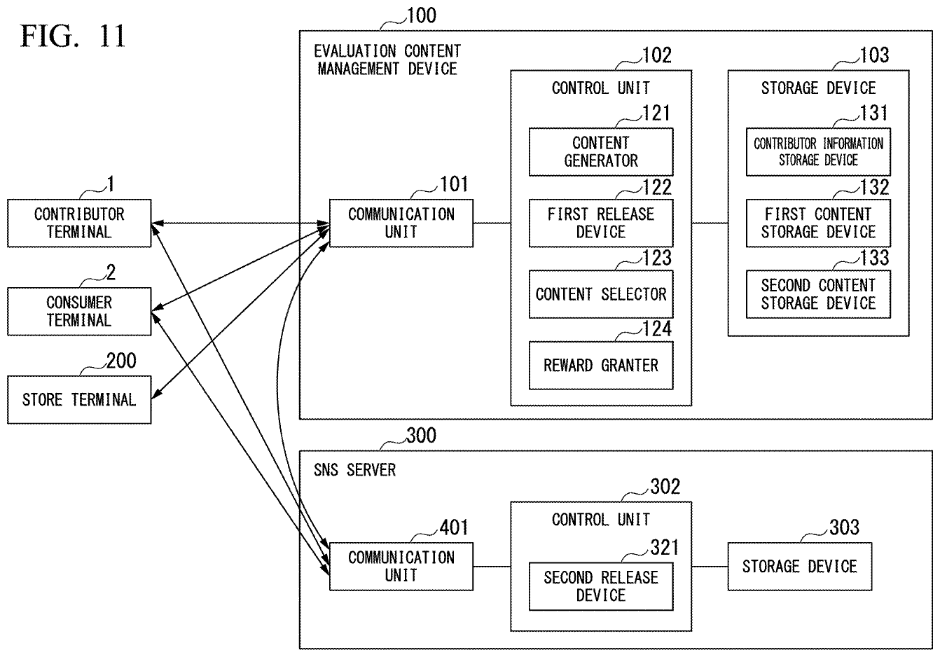

A second embodiment will be described below. FIG. 10 illustrates an example of the entire configuration of an evaluation content management system according to the second embodiment. In the drawing, the same elements as illustrated in FIG. 1 will be referred to by the same reference signs, and description thereof will be appropriately omitted.

In the present embodiment, a social networking service (SNS) 40 (an example of a second environment) is used. The SNS 40 receives contribution of SNS content including text and images (a still image and a moving image) from a registered user and releases the contributed SNS content over the network. This SNS function is realized by an SNS server 300 provided in the network.

In the drawing, users of the SNS 40 serve as a contributor CT and a consumer user US. The consumer user US is a user who is a consumer purchasing a product or a service provided by a store 20. The contributor CT uses the SNS 40 using a contributor terminal 1, and the consumer user US uses the SNS 40 using a consumer terminal 2. The consumer user US can also access the reputation information site 10 using the consumer terminal 2.

The consumer terminal 2 may be a smartphone, a tablet terminal, a personal computer, or the like.

In the present embodiment, a contributor CT contributes SNS content introducing evaluation content in the site format contributed to the reputation information site 10 to the SNS 40. In this way, for example, a link (URL) of evaluation content to be introduced is added to the SNS content introducing the evaluation content in the site format, and thus the evaluation content may be embedded therein.

A consumer user US accesses the SNS 40 and views the SNS content contributed by the contributor CT. The consumer user US is interested in the evaluation content in the site format embedded in the SNS content contributed by the contributor CT. Therefore, the consumer user US operates the link associated with the evaluation content in the site format in the SNS content and accesses the evaluation content in the site format released in a reputation information site.

The consumer user US views the accessed evaluation content in the site format. In this case, the evaluation content in the site format viewed by the consumer user US is for evaluating a product which is sold by a store 20. The screen of the evaluation content in the site format viewed by the consumer user US is configured to receive an operation of ordering the product which is an evaluation target (an ordering operation).

It is assumed that the consumer user US orders the product which is the evaluation target by viewing the evaluation content. Therefore, the consumer user US performs an ordering operation for ordering the product which is the evaluation target.

When the ordering operation is performed, order information is transmitted from the evaluation content management device 100 to the store terminal 200 of the store 20. At this time, a server performing an order receiving process or the like may be interposed between the evaluation content management device 100 and the store terminal 200.

The store terminal 200 having received order information performs a process such as notification of order reception to a clerk or order management (an order coping process).

Two types of an in-store order and an online order can be used as an order from a consumer user US.

The in-store order is, for example, a type in which a product such as food is ordered in a state in which a consumer user US is present is in a store 20 to be evaluated by the viewed evaluation content. In the in-store order, the store 20 generates the ordered product and immediately hands over the product to the consumer user US.

The online order is a type in which a product is ordered to a store 20 which is an EC site.

When an order is made from evaluation content released in the reputation information site 10 as described above, the evaluation content management device 100 grants a reward to a contributor CT of the evaluation content from which the order has been made.

In the present embodiment, a contributor CT generates evaluation content in consideration of what details consumer users US are highly interested in in order to receive as many rewards as possible. As a result, according to the present embodiment, it is possible to enhance the quality of evaluation content in the site format.

In the drawing, a signage 21 (FIG. 1) is omitted in the store 20, but reproduction of evaluation content in the signage format in the signage 21 and giving a reward to a contributor CT in response to reproduction of evaluation content may also be performed in the present embodiment similarly to the first embodiment.

FIG. 11 illustrates an example of a functional configuration of the evaluation content management device 100 and the SNS server 300 according to the present embodiment. In the drawing, the same elements as illustrated in FIG. 5 will be referred to by the same reference signs, and description thereof will be appropriately omitted.

The configuration of the evaluation content management device 100 in the drawing is the same as illustrated in FIG. 5.

The SNS server 300 includes a communication unit 301, a control unit 302, and a storage device 303.

The communication unit 301 is communicatively connected to the evaluation content management device 100, the contributor terminal 1, the consumer terminal 2, and the like via a network.

The control unit 302 performs various types of control in the SNS server 300. The control unit 302 includes a second disclosure unit 321.

As described above with reference to FIG. 10, a contributor CT operates the contributor terminal 1 to generate SNS content introducing evaluation content in the site format contributed to the evaluation content management device 100 and to contribute the generated SNS content to the SNS 40.

The second disclosure unit 321 releases the evaluation content in the second environment by disclosing the SNS content introducing the evaluation content in the site format contributed as described above in the SNS 40.

The storage device 303 stores various types of information corresponding to the SNS server 300. The storage device 303 may store, for example, the contributed SNS content.

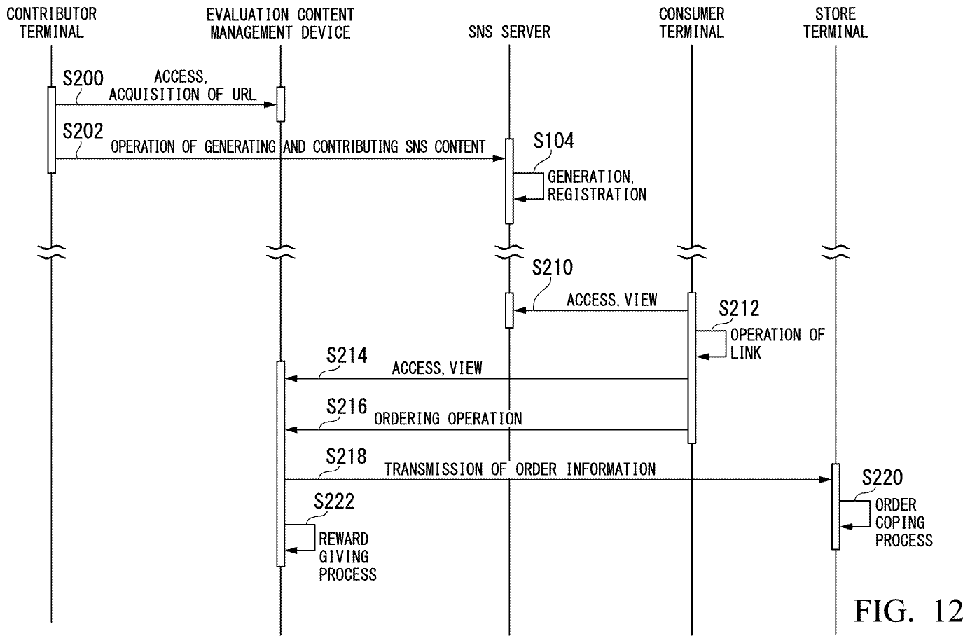

An example of a sequence that is performed to correspond to contribution of SNS content and giving a reward in response to an order via the evaluation content from a consumer user US in the evaluation content management system according to the present embodiment will be described below with reference to a sequence diagram illustrated in FIG. 12.

An example of a sequence corresponding to contribution of SNS content introducing evaluation content in the site format will be first described.

Step S200: A contributor CT operates the contributor terminal 1 to access evaluation content contributed by the contributor and currently introduced out of evaluation content in the site format released in the reputation information site 10 by the first release device 122 of the evaluation content management device 100 and to acquire an URL of the evaluation content which is an access destination.

Step S202: Then, the contributor CT operates the contributor terminal 1 to access the SNS server 300 and to perform an operation for generating SNS content and contributing the generated SNS content. Here, the contributor CT generates SNS content in which evaluation content to be introduced is embedded by adding the URL acquired in Step S200 thereto. The contributor CT performs an operation of contributing the generated SNS content to the SNS 40 using the contributor terminal 1.

Step S204: The second disclosure unit 321 of the SNS server 300 performs a process of generating SNS content and a process of registering the generated SNS content according to the operation for generation and contribution of the SNS content performed using the contributor terminal 1 which is an access source. Registration of SNS content may be performed by storing the generated SNS content in the storage device 303.

An example of a sequence corresponding to giving a reward to a contributor CT in response to an order from a consumer user US will be described below.

Step S210: A consumer user US operates a consumer terminal 2 to access the SNS content introducing evaluation content released in the SNS 40 by the first release device 122 of the SNS server 300. The consumer user US views the SNS content which is reproduced by the consumer terminal 2 through the access.

Step S212: The consumer user US operates a link (URL) of the evaluation content to be introduced embedded in the SNS content which is viewed using the consumer terminal 2.

Step S214: The consumer terminal 2 accesses the evaluation content to be introduced designated by the URL of the link destination according to the operation in Step S212. The accessed evaluation content to be introduced is displayed in the consumer terminal 2. The consumer user US can view the displayed evaluation content.

Step S216: The consumer user US performs an ordering operation on the evaluation content displayed in the consumer terminal 2.

The reward granter 124 of the evaluation content management device 100 receives the ordering operation. When the ordering operation is received, the reward granter 124 acquires, for example, information for identifying a store 20 and a product of an ordering target correlated with the evaluation content (a store ID and a product ID). The reward granter 124 may acquire, for example, information (payment information) used for payment such as a credit card number according to an input operation of the consumer user US. The reward granter 124 may also acquire information such as a product delivery destination when the order type is an online order.

Step S218: The reward granter 124 of the evaluation content management device 100 transmits order information to the store 20 indicated by the store ID acquired in Step S216. The order information includes a product ID of an ordering target and payment information. When the order type is an online order, the order information may also include information such as a product delivery destination.

Step S220: The store terminal 200 performs an order coping process based on the order information transmitted in Step S218.

Step S222: The reward granter 124 of the evaluation content management device 100 performs a reward giving process for the contributor CT of the evaluation content corresponding to the order information in response to transmission of the order information in Step S218. The reward grantn in Step S222 is a price for promoting selling of a product to be evaluated by the evaluation content.

### Third Embodiment

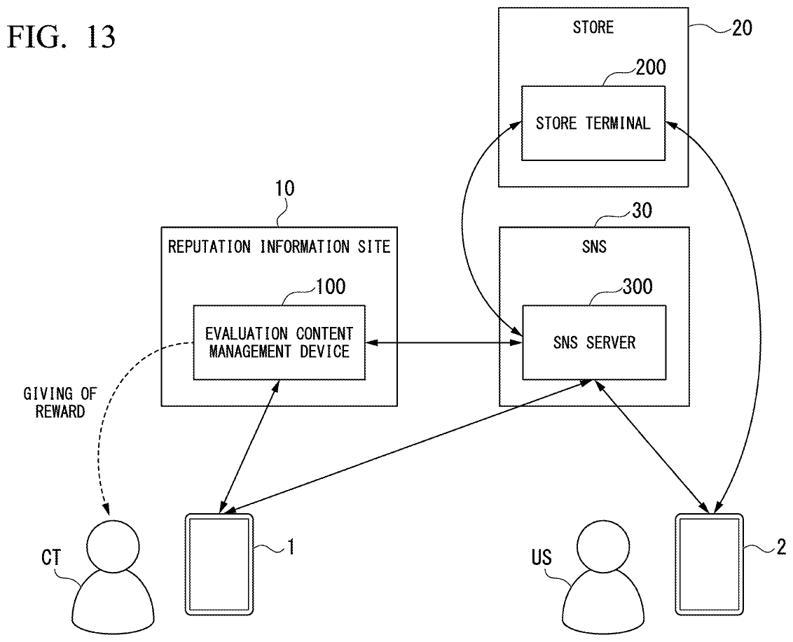

A third embodiment will be described below. FIG. 13 illustrates an example of the entire configuration of an evaluation content management system according to the third embodiment. In the drawing, the same elements as illustrated in FIGS. 1 and 10 will be referred to by the same reference signs, and differences from FIG. 10 will be mainly described.

In the present embodiment, a consumer terminal 2 of a consumer user US communicates with the SNS server 300 and also communicates with the store terminal 200 of the store 20. By causing the consumer terminal 2 and the store terminal 200 to communicate with each other in this way, the consumer terminal 2 can make an order to the store terminal 200 in the present embodiment.

In the present embodiment, the store terminal 200 of the store 20 and the SNS server 300 of the SNS 40 are connected.

In the present embodiment, similarly to the second embodiment, a contributor CT generates SNS content introducing evaluation content (the site format) contributed to the reputation information site 10 and contributes the generated SNS content to the SNS 40.

A consumer user US can access the SNS 40 and view the SNS content contributed by the contributor CT.

It is assumed that the consumer user US also orders a product of the store 20 evaluated by the evaluation content introduced by the viewed SNS content.

The ordering may be performed, for example, in a face-to-face manner with a clerk in the store 20 which the consumer user US has visited or may be an online order which is made by causing the consumer user US to operate the consumer terminal 2.

The store 20 copes with the order from the consumer user US. When the store 20 receives the order, the store terminal 200 accesses the SNS server 300 and searches for the SNS content in which the evaluation content in the site format having evaluated the product ordered in the store is introduced (embedded). In the search, a word described in a tag added to the SNS content may be used as a search target.

The store 20 determines by what evaluation content in the site format the consumer user US was motivated to make the order according to details of the evaluation content in the site format embedded in the searched-for SNS content.

The determination of evaluation content may be performed by a clerk or may be performed by the store terminal 200. When the determination is performed by the store terminal 200, evaluation content serving as motivation of the order may be estimated on the basis of the ordered product, attributes such as age or sex of the consumer user having ordered the product, and details of evaluation content. The store terminal 200 may estimate the evaluation content serving as motivation of the order using a trained model.

The store terminal 200 notifies the evaluation content management device 100 of the evaluation content determined to serve as motivation of the order, for example, via the SNS server 300.

The evaluation content management device 100 grants a reward which is a price for promoting selling of the product to be evaluated by the evaluation content to a contributor of the notified evaluation content.

In the present embodiment, the evaluation content management device 100 may grant a reward in consideration of evaluation items such as the number of views of the SNS content in which the notified evaluation content is embedded and the number of “likes.”

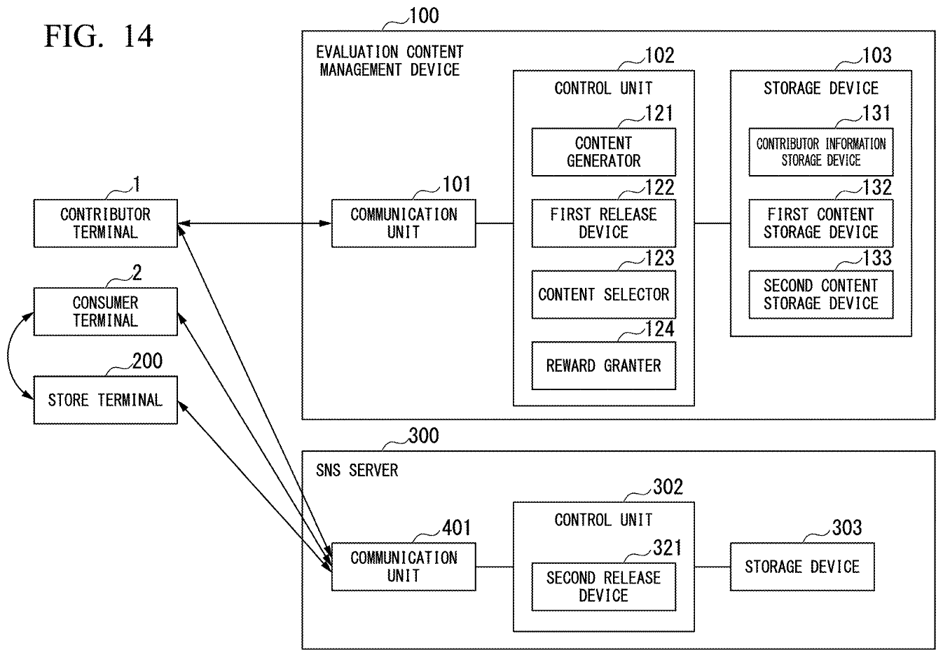

FIG. 14 illustrates an example of a functional configuration of the evaluation content management device 100 and the SNS server 300 according to the present embodiment. In the drawing, the same elements as illustrated in FIG. 11 will be referred to by the same reference signs, and differences from FIG. 11 will be mainly described.

In the present embodiment, the consumer terminal 2 of the consumer user US is communicatively connected to the store terminal 200 of the store 20. The store terminal 200 of the store 20 and the SNS server 300 in the SNS 40 are communicatively connected.

The configurations of the evaluation content management device 100 and the SNS server 300 may be the same as illustrated in FIG. 11.

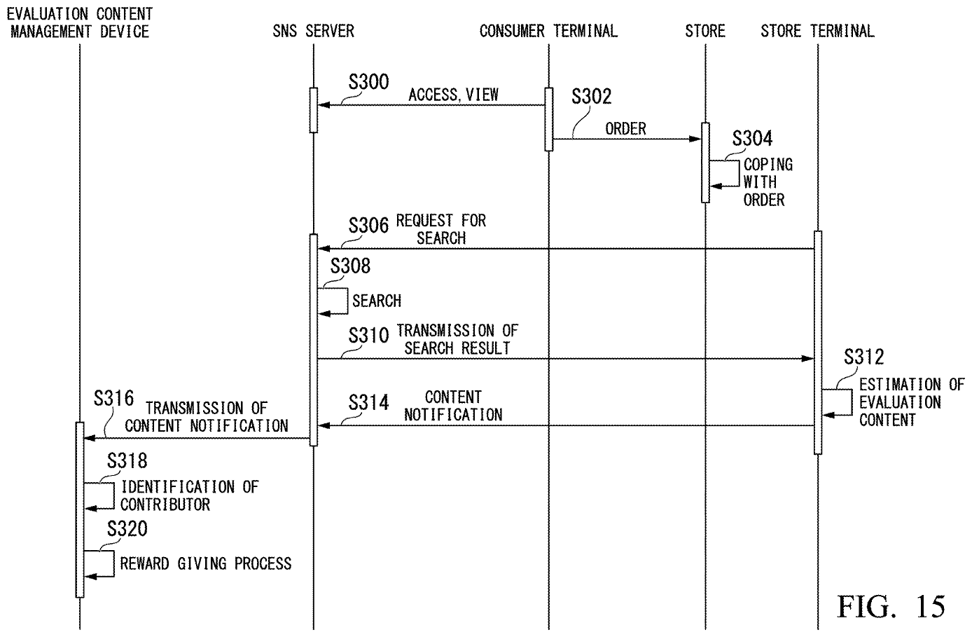

An example of a sequence that is performed to correspond to giving a reward in response to an order from a consumer user US via evaluation content in the evaluation content management system according to the present embodiment will be described below with reference to a sequence diagram illustrated in FIG. 15.

Contribution of SNS content in the present embodiment may be the same as the processes of Steps S200 to S204 in FIG. 12.

A sequence of receiving an order in the present embodiment will be first described.

Step S300: The consumer user US operates the consumer terminal 2 to access SNS content introducing evaluation content released in the SNS 40 by the first release device 122 of the SNS server 300. The consumer user US views the SNS content which is reproduced by the consumer terminal 2 through the access.

Step S302: The consumer user US orders a product evaluated by the evaluation content embedded in the SNS content displayed on the consumer terminal 2 in the store 20.

Step S304: The store 20 copes with the order received from the consumer user US. For example, when the consumer user US makes an order in the store 20, a clerk of the store 20 deals with the consumer user US and performs handover of the ordered product and accounting. When the order type is an online order, an EC server corresponding to the store performs processes such as payment and delivery generation of the product.

An example of a sequence of giving a reward in response to ordering a product will be described below.

Step S306: A clerk of the store 20 operates the store terminal 200 to access the SNS server 300 and causes the store terminal 200 to transmit an SNS content search request. At this time, the clerk may set, for example, a store ID and a product name as search conditions.

Step S308: The SNS server 300 searches for the SNS content in response to the search request transmitted in Step S306.

Step S310: The SNS server 300 transmits the search result in Step S308 to the store terminal 200. The search result may include a content ID and actual data for each piece of searched evaluation content.

Step S312: The store terminal 200 estimates evaluation content serving as motivation of the consumer user US for this order out of the evaluation content embedded in the SNS content acquired as the search result. As described above, the evaluation content serving as motivation of the consumer user US may be determined by the clerk.

Step S314: The store terminal 200 transmits a content notification including the content ID of the evaluation content estimated in Step S312 to the SNS server 300.

Step S316: The SNS server 300 transmits the content notification transmitted in Step S314 to the evaluation content management device 100.

Step S318: The reward granter 124 of the evaluation content management device 100 identifies a contributor CT of the evaluation content identified by the content ID included in the content notification transmitted in Step S316.

Step S320: The reward granter 124 performs the reward giving process for the contributor CT identified in Step S318.

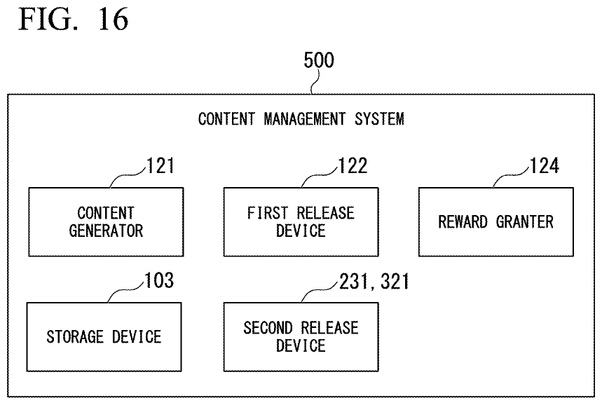

An example of a basic configuration according to an embodiment will be described with reference to FIG. 16. FIG. 16 is a diagram illustrating a principal configuration of a content management system according to the present embodiment.

The content management system according to the present embodiment includes the content generator 121, the first release device 122, the storage device 103, the second release device (231, 321), and the reward granter 124.

The content generator 121 generates evaluation content including details associated with evaluation of a facility itself or a commodity provided at the facility in association with a contributor CT.

The first release device 122 releases the evaluation content generated by the content generator 121 in a first environment which is an evaluation content site.

The storage device 103 stores the evaluation content released by the first release device 122 in association with reaction information indicating a reaction status with respect to the released evaluation content.

The second release device (231, 321) releases the evaluation content generated by the content generator 121 in a predetermined second environment different from the first environment.

The reward granter 124 grants a reward to the contributor CT corresponding to the evaluation content on the basis of the evaluation content released by the second release device (231, 321).

The contributor terminal 1, the consumer terminal 2, the evaluation content management device 100, the store terminal 200, the signage 21, the SNS server 300, and the like according to the aforementioned embodiments may be realized by computers. In this case, these functions may be realized by recording a program for realizing the functions on a computer-readable recording medium and causing a computer system to read and execute the program recorded on the recording medium. The “computer system” mentioned herein includes an OS or hardware such as peripherals. The “computer-readable recording medium” is a portable medium such as a flexible disk, a magneto-optical disc, a ROM, or a CD-ROM or a storage device such as an HDD or an SSD incorporated into a computer system. The “computer-readable recording medium” may include a medium that dynamically holds a program for a short time such as a communication line when a program is transmitted via a network such as the Internet or a communication circuit line such as a telephone line or a medium that holds a program for a predetermined time such as a volatile memory in a computer system serving as a server or a client in that case. The program may be a program for realizing some of the aforementioned functions, may be a program for realizing the aforementioned functions in combination with another program stored in advance in the computer system, or may be a program for realizing the aforementioned functions using a programmable logic device such as a field-programmable gate array (FPGA).

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Contributor terminal
2 Consumer terminal
10 Reputation information site
20 Store
21 Signage
100 Evaluation content management device
101 communication unit
102 Control unit
103 Storage device
121 Content generator
122 First release device
123 Content selector
124 Reward granter
131 Contributor information storage device
132 First content storage device
133 Second content storage device
200 Store terminal
201 Communication unit
202 User interface unit
203 Control unit
204 Storage device
231 Second release device
300 SNS server
301 Communication unit
302 Control unit
303 Storage device
321 Second release device

What is claimed is:

1. A content management system comprising:
a content generator configured to generate evaluation contents which are respectively associated with contributors, wherein each of the evaluation contents includes details of evaluation of a facility or of a commodity provided at the facility;
a first release device configured to release the evaluation contents, which have been generated by the content generator, in a first environment of an evaluation content site;
a storage device configured to store the evaluation contents released by the first release device in association with reaction information indicating reactions to the evaluation contents as released;
a content selector configured to select an evaluation content out of the evaluation contents stored in the storage device on the basis of the reaction information;
a second release device configured to release all or part of the evaluation content selected by the content selector in a second environment that is different from the first environment; and
a reward granter configured to grant a reward to the contributor associated with the evaluation content released on the basis of the evaluation content released by the second release device.

2. The content management system according to claim 1, wherein the content selector is configured to extract the evaluation content including details of evaluation of a designated facility or a designated commodity out of commodities provided at the facility.

3. The content management system according to claim 1, wherein the second environment includes a display device which is disposed at a predetermined place, and
wherein the reward granter is configured to grant a reward to the contributor associated with the evaluation content, in response to reproduction of the evaluation content by the display device.

4. The content management system according to claim 1, wherein the second environment includes a display device which is disposed at a predetermined place, and
wherein the reward granter is configured to grant a reward to the contributor associated with the evaluation content in response to a detection of a user's reaction to the evaluation content displayed by the display device.

5. The content management system according to claim 1, wherein the second environment includes a display device which is disposed at a predetermined place, and
wherein the content selector is configured to select an evaluation content to be reproduced by the display device, out of the evaluation contents which are associated with a user of the display device.

6. The content management system according to claim 1, wherein the content generator is configured to perform generation of a first evaluation content in a first format supporting for disclosure of the in the first environment and generation of second evaluation content in a second format supporting for disclosure in the second environment.

7. The content management system according to claim 6, wherein the content selector is configured to select, as a selection candidate, the second evaluation content out of the first and second evaluation contents generated.

8. The content management system according to claim 7, wherein the second environment includes a display device which is a signage disposed at a predetermined place,
wherein the second release device is configured to cause the display device to reproduce the second evaluation content in the second format supporting for reproduction in the display device, and
wherein the reward granter is configured to grant a reward to the contributor associated with the second evaluation content in case that the second evaluation content has been reproduced by the display device.

9. The content management system according to claim 7, wherein the second environment includes a display device which is a signage disposed at a predetermined place,
wherein the second release device is configured to cause the display device to reproduce the second evaluation content in the second format supporting for reproduction in the display device, and
wherein the reward granter is configured to grant a reward to the contributor associated with the second evaluation content in case that a user's reaction to the evaluation content displayed by the display device has been detected.

10. The content management system according to claim 1, wherein the second environment is a social network service (SNS),
wherein the second release device is configured to release the evaluation content in a predetermined format in SNS contents contributed to the SNS, and
wherein the reward granter is configured to grant a reward to the contributor associated with the evaluation content in case that occurrence of viewing or interaction of the evaluation content released in the SNS content has been identified.

11. A content management method in a content management system, the content management method comprising:
causing a content generator to generate evaluation content including details of evaluation of a facility itself or a commodity provided at the facility in association with a contributor;
causing a first release device to release the evaluation content generated in a first environment which is an evaluation content site;
causing a storage device to store the evaluation content released by the first release device in association with reaction information indicating a reaction status with respect to the released evaluation content;
causing a content selector to select evaluation content out of the evaluation content stored in the storage device on the basis of the reaction information;
causing a second release device to release all or part of the evaluation content selected in a predetermined second environment different from the first environment; and
causing a reward granter to grant a reward to the contributor associated with the evaluation content on the basis of the evaluation content released.
